(19) United States
(12) Patent Application Publication
(10) Pub. No.: US 2020/0314304 A1
(43) Pub. Date: Oct. 1, 2020

(54) Flashlight Camera System

(71) Applicant: Eric Klahn, Lowell, MI (US)

(72) Inventor: Eric Klahn, Lowell, MI (US)

(21) Appl. No.: 16/798,764

(22) Filed: Feb. 24, 2020

Related U.S. Application Data
(60) Provisional application No. 62/823,899, filed on Mar. 26, 2019.

(51) Int. Cl. H04N 5/225; G03B 17/56; H04N 5/76

(52) U.S. Cl. CPC H04N 5/2256; G03B 17/561; G03B 17/563; H04N 5/76; H04N 5/2253; H04N 5/22525; H04N 5/2252

(57) ABSTRACT

A flashlight camera system. The flashlight camera system includes a housing having a first portion and a second portion, wherein a light source is disposed on the first portion. A camera is disposed on the first portion at a distal end of the first portion. A motion sensor is operably connected to the camera and the light source, wherein the camera and the light source are activated when the motion sensor detects motion. A power source is disposed within the housing and is operably connected to each of the light source, the camera, and the motion sensor. The second portion includes a handle thereon.

### CROSS REFERENCE TO RELATED APPLICATIONS

This application claims the benefit of U.S. Provisional Application No. 62/823,899 filed on Mar. 26, 2019. The above identified patent application is herein incorporated by reference in its entirety to provide continuity of disclosure.

### BACKGROUND OF THE INVENTION

The present invention relates to flashlight camera systems. More particularly, the present invention pertains to flashlight camera systems having a motion sensor to activate the light and camera when motion is detected.

Many people use traditional flashlights when working in low light areas, walking outside, and the like. These flashlights require the use to hold the flashlight in one hand, resulting in frustration when performing activities that require the use of both hands. Furthermore, some locations are unsuited to holding a flashlight to illuminate a desired area, such as beneath a vehicle or other tight confines. Additionally, many people may desire to take a picture or record the area illuminated by the flashlight but doing so one-handed with a secondary device can be difficult. Therefore, there is a need in the art for a flashlight device that can be secured to another object to illuminate a desired area in a hands-free capacity, while also enabling a user to take photos or videos of the illuminated area.

In light of the devices disclosed in the known art, it is submitted that the present invention substantially diverges in design elements from the known art and consequently it is clear that there is a need in the art for an improvement to existing flashlight camera systems. In this regard, the instant invention substantially fulfills these needs.

### SUMMARY OF THE INVENTION

In view of the foregoing disadvantages inherent in the known types of flashlight camera systems now present in the known art, the present invention provides a flashlight camera system wherein the same can be utilized for providing convenience for the user when inspecting and recording objects in low light conditions.

The present system comprises a housing having a first portion and a second portion, wherein a light source is disposed on the first portion. A camera is disposed on the first portion at a distal end thereof. A motion sensor is operably connected to the camera and the light source, wherein the camera and the light source are activated when the motion sensor detects motion. A power source is disposed within the housing and is operably connected to each of the camera, the light source, and the motion sensor. The second portion comprises a handle thereon. In this way, the housing can be used to record or photograph an area illuminated by the light source upon motion detection, such that a user does not need to actuate a separate activation control, thereby allowing hands-free illumination and recording of a desired work surface.

In some embodiments, a mounting bracket is securable to the housing, wherein the mounting bracket includes a hook affixed to an upper end thereof. In some embodiments, the mounting bracket comprises an L-shaped arm pivotally secured to a lower end of the mounting bracket at a first end thereof. In such embodiments, a pair of arcuate arms are pivotally affixed to a second end of the L-shaped arm, such that the pair of arcuate arms are removably securable to the housing. In some embodiments, a recess is disposed in the second portion, wherein the recess is dimensioned to receive the pair of arcuate arms therein. In another embodiment, the pair of arcuate arms are flush with an exterior surface of the second portion when secured within the recess. In other embodiments, the mounting bracket further comprises at least one magnet therein. In yet another embodiment, the hook is pivotally affixed to the mounting bracket. In this way, the housing can be removably secured to a variety of support surfaces.

In some embodiments, a display screen is disposed on the second portion opposite the camera, and wherein the display screen is configured to display a video feed recorded by the camera. In this way, the user can view the display screen when the camera is in use. In other embodiments, the power source is rechargeable and operably connected to an external port disposed on the housing, such that the external port is configured to transmit power to the power source. In another embodiment, the camera is configured to record an image to a memory disposed within the housing when the motion sensor is actuated while the power source is being charged. In this way, the area about the housing can be recorded when the device is not in use to monitor the surrounding area, thereby deterring theft.

In some embodiments, the first portion is slidably disposed within the second portion, such that the first portion is selectively movable between an extended position and a collapsed position. In other embodiments, the light source is covered by the second portion when the first portion is in the collapsed position. In this way, the light source is protected from damage by the second portion when the light source is not in use. In other embodiments, the light source comprises a 360-degree light source, such that an entirety of the surrounding area is illuminated thereby. In yet another embodiment, the second portion further comprises a textured surface thereon, wherein the textured surface is configured to increase frictional engagement therewith. In this way, the user can securely grip the second portion such that falling damage from the housing being dropped is minimized.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded view of an embodiment of the flashlight camera system.

FIG. 2A shows a perspective view of an embodiment of the flashlight camera system in the collapsed position.

FIG. 2B shows a perspective view of an embodiment of the flashlight camera system in the extended position.

FIG. 3 shows a perspective view of the mounting bracket of an embodiment of the flashlight camera system.

FIG. 4 shows a schematic view of an embodiment of the flashlight camera system.

### DETAILED DESCRIPTION OF THE INVENTION

Reference is made herein to the attached drawings. Like reference numerals are used throughout the drawings to depict like or similar elements of the flashlight camera system. The figures are intended for representative purposes only and should not be considered to be limiting in any respect.

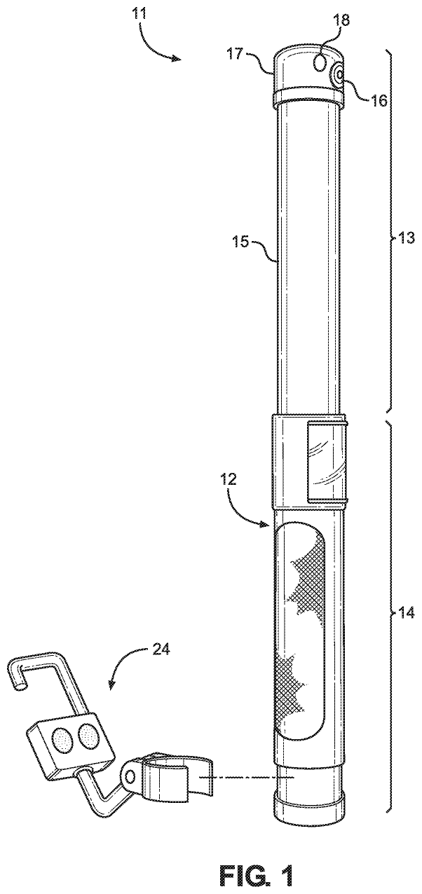

Referring now to FIG. 1, there is shown an exploded view of an embodiment of the flashlight camera system. The flashlight camera system 11 comprises a housing 12 having a first portion 13 and a second portion 14. The second portion 14 comprises a handle, such that a user is provided with a gripping surface. A light source 15 is disposed on the first portion 1 herein the light source 15 is configured illuminate the surrounding area. In the illustrated embodiment, the light source 15 comprises a 360-degree light source, such as one might find in a lantern, thereby providing illumination to an entirety of a surrounding area. In other embodiments, the light source 15 comprises a directed light source disposed on the first portion 13, such that the user can limit the area of illumination provided by the light source 13 to a desired area. The light source 15 is contemplated to include any light emitting means, such as incandescent lights, fluorescent lights, light emitting diode (LED) systems, or the like.

A camera 16 is disposed on a distal end 17 of the first portion 13. The camera 16 can comprise a video camera, a still camera, or any combination thereof, such that the camera 16 can record video or still images. The camera 16 is operably connected to a motion sensor 18 disposed on the distal end 17. The motion sensor 18 is further operably connected to the light source 15. When the motion sensor 18 detects motion, the camera 16 and the light source 15 are configured to activate. In this way, movement of the housing 12, or any movement relative to the motion sensor 18, can continually operate the camera 16 and the light source 15. This provides the user with hands-free illumination and camera 16 operation while working in tight confines, such as under a vehicle.

In the shown embodiment, a mounting bracket 24 is removably secured to the second portion 14. The mounting bracket 24 allows the user to secure the housing 12 to a support surface, such as a vehicle frame or the like, thereby allowing the housing 12 to remain stationary to provide hands-free illumination. In the illustrated embodiment, the mounting bracket 24 comprises a variety of securement mechanisms thereon, allowing the mounting bracket 24 to removably secure to a variety of surfaces. Such securement mechanisms are described elsewhere herein.

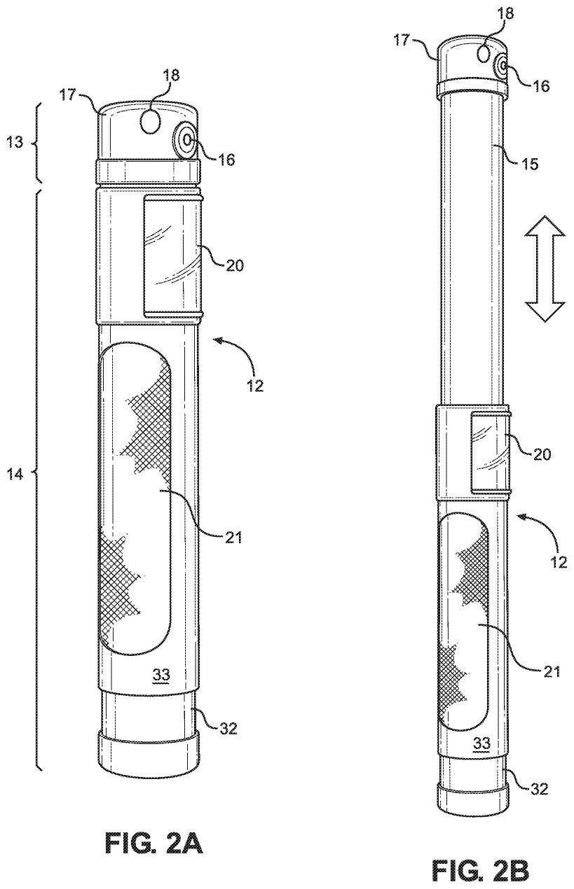

Referring now to FIGS. 2A and 2B, there is shown a perspective view of an embodiment of the flashlight camera system in the collapsed position and a perspective view of an embodiment of the flashlight camera system in the extended position, respectively. In the illustrated embodiments, the first portion 13 is slidably disposed within the second portion 14, such the that first portion 13 is selectively movable between an extended position (as shown in FIG. 2B) and a collapsed position (as shown in FIG. 2A). The collapsed position provides a minimal form factor for ease of storage and transport. While in the collapsed position, the entirety of the light source 15 is covered by the second portion 14, such that the light source 15 is provided extra protection thereby during transport and when the light source 15 is not in use. In some embodiments, the first portion 13 is further rotatably secured within the second portion 14, such that the first portion 13 is rotatable about a longitudinal axis of the second portion 14. In this way, the user can position the camera 16 and the motion sensor 18 relative to the user, thereby ensuring that the desired work surface is recorded thereby.

In the illustrated embodiments, a display screen 20 is disposed on the second portion 14 opposite the camera 16. The camera 16 is operably connected to the display screen 20, such that video or images recorded thereby are displayed on the display screen 20. In this way, the user can position the camera 16 to record a desired surface and view the recorded area on the display screen 20. This provides the user an unobstructed view of the desired work surface, as the housing 12 could otherwise obstruct the view of the work surface. Additionally, the display screen 20 allows a user to determine that the proper area is being recorded by the camera 16 to ensure proper documentation of the work surface is recorded thereby.

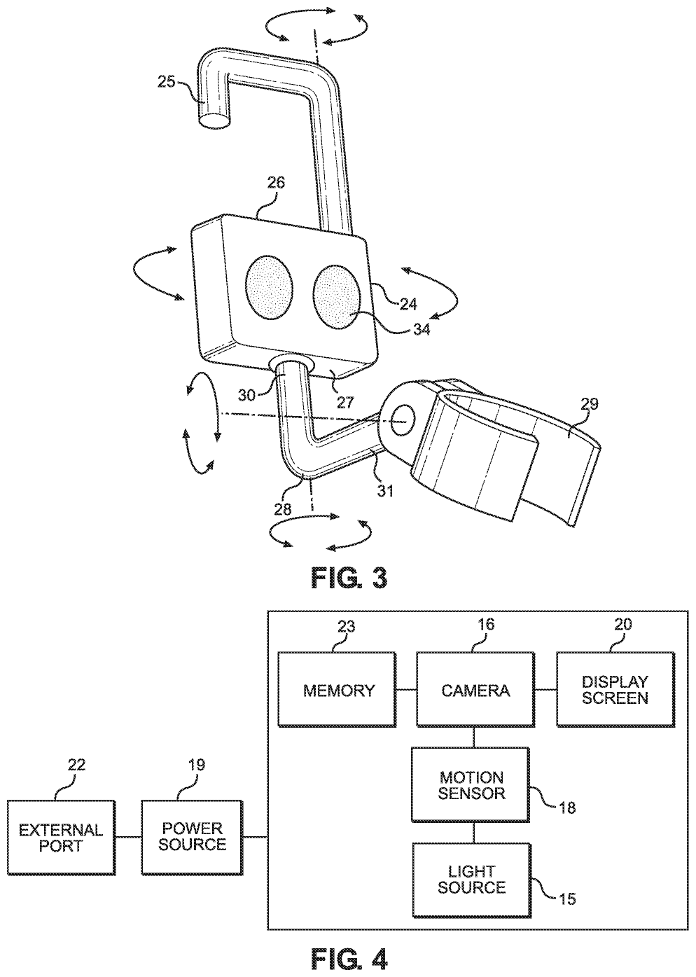

In the illustrated embodiments, a recess 32 is disposed on a lower end of the second portion 14. The recess 32 is configured to receive a securement mechanism of the mounting bracket therein, such that the mounting bracket is securely affixed to the second portion 14. In some embodiments, the securement mechanism of the mounting bracket comprises a pair of arcuate arms (as shown in FIG. 3, 29). In such embodiments, the recess 32 can be dimensioned to receive the pair of arcuate arms therein, such that an exterior surface 33 of the second portion is flush with the pair of arcuate arms when secured within the recess 32. In the illustrated embodiment, the recess 32 extends about an entire circumference of the second portion 14, thereby allowing the user to secure the mounting bracket to the second portion 14 at any desired position relative to the external surface 33.

Furthermore, in the illustrated embodiment, the second portion comprises a textured surface 21 thereon, wherein the textured surface 21 is configured to increase frictional engagement between a user and the housing 12, thereby ensuring the housing 12 is securely gripped by the user. In this way, any drop risk relative to the housing 12 is minimized. In the illustrated embodiment, the textured surface 21 is recessed within the second portion 14, such that the difference in height between the exterior surface 33 and the textured surface 21 further increases frictional engagement with the user's hand. Additionally, the textured surface 21 can be positioned along the second portion 14, such that the user can properly index the housing 12, allowing the user to easily direct the camera 16 in a desired direction by feel.

Referring now to FIG. 3, there is shown a perspective view of the mounting bracket of an embodiment of the flashlight camera system. The mounting bracket 24 is configured to removably secure to a support surface and the housing, such that the housing is supported thereby. A hook 25 is disposed on an upper end 26 of the mounting bracket 24, wherein the hook 25 is configured to allow the mounting bracket 24 to be hung from a support surface. In some embodiments, the hook 25 is pivotally affixed to the upper end 26, such that the user can position the hook 25 relative to the mounting bracket 24, thereby allowing the user more freedom in securing the mounting bracket to a variety of support surfaces. This pivotal arrangement for the hook 25 further allows the user to rotate the housing secured to the mounting bracket 24 to adjust the position thereof, thereby ensuring that the housing faces a desired direction.

In the shown embodiment, an L-shaped arm 28 is affixed to a lower end 27 of the mounting bracket 24 at a first end 30 thereof. In some embodiments, the first end 30 is pivotally secured to the mounting bracket 24 to provide additional adjustment capabilities thereto. The L-shaped arm 28 further comprises a pair of arcuate arms 29 on a second end 31 thereof. The pair of arcuate arms 29 are configured to removably secure the mounting bracket 24 to the housing via friction fit. In some embodiments, the pair of arcuate arms 29 secure within the recess such that the pair of arcuate arms 29 rest flush with the exterior surface of the second portion. In some embodiments, the pair of arcuate arms 29 are pivotally secured to the second end 31, such that the user can adjust the relative position of the housing secured within the pair of arcuate arms 29 by adjusting the position of the pair of arcuate arms 29. In this way, the user is provided with multiple axes of rotation, such that the housing can be positioned as desired when secured to a support surface by the mounting bracket 24.

In the illustrated embodiment, at least one magnet 34 is disposed within the mounting bracket 24, along a rear surface thereof, allowing a user to removably secure the mounting bracket 24 to a ferrous surface, such as a vehicle frame. Additional magnets 34 are contemplated to increase the strength of adhesion to the ferrous surface. In this way, the user is provided with an additional securement means, such that the mounting bracket 24 can be secured to a support surface by the hook 25 and the magnet 34 simultaneously. This provides an additional degree of failure, ensuring maximal safety, as if either of the hook 25 or magnet 34 fail to secure the mounting bracket 24 to the support surface, the attached housing does not fall, potentially injuring the user.

Referring now to FIG. 4, there is shown a schematic view of an embodiment of the flashlight camera system. In the illustrated embodiment, a power source 19 is disposed within the housing, wherein the power source 19 is operably connected to each of the light source 15, the motion sensor 18, the camera 16, the display screen 20, and a memory 23. The powersource 19 is contemplated to include rechargeable batteries or the like, such that the power source 19 can be reused. In the shown embodiment, an external port 22 is disposed on the housing, wherein the external port 22 is operably connected to the power source 19, such that the external port 22 is configured to transmit power to the power source 19 when in use. The external port 22 is contemplated to be any port capable of transmitting power, such as a universal serial bus (USB) port. Alternatively, in some embodiments, the housing is in wired connection with a wall outlet or other external power source 19.

Generally, during use, when the motion sensor 18 is triggered by detected movement, the light source 15 and camera 16 are activated for a set period of time, such as 30 seconds, to illuminate and record the surrounding area. In this way, the user can place the housing in a desired position facing a work surface, and movement by the user within the work area will maintain the illumination of the light source 15. This provides hands-free illumination and recording, allowing the user to maintain efficiency within the desired work area. In some embodiments, the length of time during which the light source 15 and the camera 18 are active can be adjusted as desired, thereby minimizing frustration caused by the light source 15 deactivating during use. Alternatively, a separate control, such as a toggle switch, may be disposed on the housing, the control configured to selectively activate or deactivate the light source 15 and the camera 16. In this way, the user can utilize the light source 15 and camera 16 in a traditional manner while holding the housing.

Once activated, the display screen 20 displays the active camera 16 feed, such that the user can visualize the work surface. In some embodiments, the camera 16 further comprises focus and zoom controls, allowing the user to view the work area in greater detail via the display screen 20. Furthermore, in some embodiments, the camera 16 records the video or image data on a memory 23 disposed within the housing, such that the user can review the stored video or age data at a later date. In further embodiments, the camera 16 is configured to activate and record video or image data to the memory 23 when the motion sensor 18 detects motion while the external port 22 is in active use, such as during charging. In this way, the surrounding area can be monitored via the camera 16 while the flashlight camera system is not in use, thereby deterring theft of items in the surrounding area.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A flashlight camera system, comprising:
a housing having a first portion and a second portion;
a light source disposed on the first portion;
a camera disposed on the first portion at a distal end thereof;
a motion sensor operably connected to the camera and the light source, wherein the camera and the light source are activated when the motion sensor detects motion;
a power source disposed within the housing and is operably connected to each of the light source, the camera, and the motion sensor;
wherein the second portion comprises a handle.

2. The flashlight camera system of claim 1, further comprising a display screen on the second portion opposite the camera, wherein the display screen is configured to display a video feed recorded by the camera.

3. The flashlight camera system of claim 1, wherein the first portion is slidably disposed within the second portion, such that the first portion is selectively movable between an extended position and a collapsed position.

4. The flashlight camera system of claim 3, wherein the second portion covers the light source when the first portion is in the collapsed position.

5. The flashlight camera system of claim 1, wherein the second portion comprises a textured surface thereon, the textured surface configured to increase frictional engagement therewith.

6. The flashlight camera system of claim 1, wherein the light source comprises a 360-degree light source.

7. The flashlight camera system of claim 1, wherein the power source is rechargeable and operably connected to an external port disposed on the housing, such that the external port is configured to transmit power to the power source.

8. The flashlight camera system of claim 7, wherein the camera is configured to record an image to a memory disposed within the housing when the motion sensor is actuated while the power source is being charged.

9. A flashlight camera system, comprising:
a housing having a first portion and a second portion;
a light source disposed on the first portion;
a camera disposed on the first portion at a distal end thereof;
a motion sensor operably connected to the camera and the light source, wherein the camera and the light source are activated when the motion sensor detects motion;
a power source disposed within the housing and is operably connected to each of the light source, the camera, and the motion sensor;
wherein the second portion comprises a handle;
a mounting bracket securable to the housing, wherein the mounting bracket includes a hook affixed to an upper end thereof.

10. The flashlight camera system of claim 9, further comprising an L-shaped arm pivotally secured to a lower end of the mounting bracket at a first end thereof, wherein a pair of arcuate arms are pivotally affixed to a second end of the L-shaped arm, such that the pair of arcuate arms are removably securable to the housing.

11. The flashlight camera system of claim 10, further comprising a recess disposed in the second portion, wherein the recess is dimensioned to receive the pair of arcuate arms therein.

12. The flashlight camera system of claim 11, wherein the pair of arcuate arms are flush with an exterior surface of the second portion when secured within the recess.

13. The flashlight camera system of claim 9, wherein the mounting bracket further comprises at least one magnet therein.

14. The flashlight camera system of claim 9, wherein the hook is pivotally affixed to the mounting bracket.

15. The flashlight camera system of claim 9, further comprising a display screen on the second portion opposite the camera, wherein the display screen is configured to display a video feed recorded by the camera.

16. The flashlight camera system of claim 9, wherein the first portion is slidably disposed within the second portion, such that the first portion is selectively movable between an extended position and a collapsed position.

17. The flashlight camera system of claim 16, wherein the second portion covers the light source when the first portion is in the collapsed position.

18. The flashlight camera system of claim 9, wherein the light source comprises a 360-degree light source.

19. The flashlight camera system of claim 9, wherein the power source is rechargeable and operably connected to an external port disposed on the housing, such that the external port is configured to transmit power to the power source.

20. The flashlight camera system of claim 19, wherein the camera is configured to record an image to a memory disposed within the housing when the motion sensor is actuated while the power source is being charged.
